(19) United States
(12) Patent Application Publication
(10) Pub. No.: US 2020/0221723 A1
(43) Pub. Date: Jul. 16, 2020

(54) THREADED CHOCOLATE AND MANUFACTURING METHOD

(71) Applicant: OA Center Co., Ltd., Kitakyushu-shi, Fukuoka (JP)

(72) Inventors: Futoshi YOSHITAKE, Kitakyushu-shi, Fukuoka (JP); Atsushi YOSHITAKE, Kitakyushu-shi, Fukuoka (JP)

(21) Appl. No.: 16/621,212

(22) PCT Filed: Aug. 9, 2018
(86) PCT No.: PCT/JP2018/029939

§ 371 Date: Dec. 10, 2019

(30) Foreign Application Priority Data
Sep. 19, 2017 (JP) 2017-178877
Nov. 1, 2017 (JP) 2017-211512
Jul. 31, 2018 (JP) 2018-143306

(51) Int. Cl. A23G 1/50; A23G 1/22

(52) U.S. Cl. CPC A23G 1/50; A23G 1/22

(57) ABSTRACT

A threaded chocolate includes a bolt-shaped chocolate having a shape of a bolt; and a nut-shaped chocolate having a shape of a nut and formed to be fitted to the bolt-shaped chocolate. Shapes of threads of the bolt-shaped chocolate and the nut-shaped chocolate are each formed by a differentiable curve, and the shapes of the threads each have arc-shaped crests and arc-shaped roots. A radius R of each of arc shapes of the arc-shaped crests and roots is four or more times 0.1 mm and twelve or less times 0.1 mm.

### TECHNICAL FIELD

The present disclosure relates to a threaded chocolate and a manufacturing method thereof.

### BACKGROUND ART

Conventional methods for molding chocolate into a desired shape includes a method in which (i) liquid chocolate is cast in a cavity that is formed in a mold and that has the desired shape, (ii) the liquid chocolate is hardened in the mold, and (iii) the solidified chocolate is pushed or pulled out of the mold (for example, refer to Patent Literatures 1 and 2).

### CITATION LIST

### Patent Literature

Patent Literature 1: Unexamined Japanese Patent Application Kokai Publication No. H10-42788

Patent Literature 2: Unexamined Japanese Patent Application Kokai Publication No. H05-168413

### SUMMARY

### Technical Problem

Although, chocolate is molded into various shapes, among such shapes, there are shapes for which pushing or pulling the molded chocolate out of a mold is difficult. Prime examples of such shapes include bolts and nuts. This is due to, when the chocolate is pushed or pulled out of a mold, screw threads becoming chipped, and thus the entire chocolate might break. Such difficulty causes a reduction of a production yield.

In this case, the bolt-shaped or nut-shaped chocolate may be pushed or pulled out of the mold while the bolt-shaped or nut-shaped chocolate rotated around the thread axis thereof. However, this method takes too much time. Alternatively, a split mold is used. In this case, the split mold is split into parts after formation of the chocolate, although the split mold part to which the solidified chocolate sticks may vary from one molding operation to another. Accordingly, since a large number of chocolates are formed at the same time, when the split mold part to which the chocolate sticks varies, the recovery of the chocolates is time-consuming, and thus such processing is unsuitable for mass production.

The mold for molding chocolate is made of flexible material, such as a resin. Accordingly, in a case in which a large number of chocolates is molded at the same time, deforming, pushing, and then pulling the chocolates out of the mold is simplest and fastest.

Formation of chocolates having low heights of thread engagement, that is, bolt and nut threads having low heights, is preferable for safely pushing or pulling these chocolates in the axial direction. However, operation such as rotation of the nut fitted onto the bolt by the fingers are difficult when the height of the bolt and nut threads is excessively low. One of the fascinations of the bolt-shaped and nut-shaped chocolates is an ability to play by rotating with the bolt fitted into the nut without looseness. Accordingly, the rotatability of the bolt with the nut fitted thereon is not to be ignored.

Additionally, demand exists for forming the bolt-shaped and nut-shaped chocolates into bite-sized pieces. In this case, dimensions such as the effective diameter and thickness of the thread are small, breakage easily occurs, and thus the manufacture of bolt-shaped chocolates onto which the nut can be rotatably fitted is more difficult.

In consideration of the aforementioned circumstances, and an objective of the present disclosure is to provide a bite-sized threaded chocolate, and a manufacturing method thereof, having a small overall size and improved production yield.

### Solution to Problem

In order to attain the aforementioned objective, a threaded chocolate according to a first aspect of the present disclosure includes: a bolt-shaped chocolate having a shape of a bolt; and a nut-shaped chocolate having a shape of a nut and formed to be fitted to the bolt-shaped chocolate, wherein shapes of screw threads of the bolt-shaped chocolate and the nut-shaped chocolate are each formed by a differentiable curve, the shapes of the screw threads each have arc-shaped crests and arc-shaped roots, and a radius of each of arc shapes of the arc-shaped crests and roots is four or more times 0.1 mm and twelve or less times 0.1 mm.

In this case, the bolt-shaped chocolate and the nut-shaped chocolate may be each formed into a bite-shaped piece.

The bolt-shaped chocolate and the nut-shaped chocolate may be different from each other in flavor.

A manufacturing method of making a threaded chocolate according to a second aspect of the present disclosure, the threaded chocolate includes: a bolt-shaped chocolate having a shape of a bolt; and a nut-shaped chocolate having a shape of a nut and formed to be fitted to the bolt-shaped chocolate, shapes of screw threads of the bolt-shaped chocolate and the nut-shaped chocolate being each formed by a differentiable curve, the shapes of the screw threads each having arc-shaped crests and arc-shaped roots, a radius of each of arc shapes of the arc-shaped crests and roots being four or more times 0.1 mm and twelve or less times 0.1 mm, the manufacturing method includes:

making a bolt shape forming mold for forming the bolt-shaped chocolate and a nut shape forming mold for forming the nut-shaped chocolate;

casting liquid chocolate into the bolt shape forming mold or the nut shape forming mold to shape the liquid chocolate into the bolt-shaped chocolate or the nut-shaped chocolate;

deforming the bold shape forming mold or the nut shape forming mold to remove the bolt-shaped chocolate or the nut-shaped chocolate from the bold shape forming mold or the nut shape forming mold; and

pulling the bolt-shaped chocolate or the nut-shaped chocolate out of the bold shape forming mold or the nut shape forming mold.

In this case, the bolt-shaped chocolate and the nut-shaped chocolate may be pulled downward.

### Advantageous Effects of Invention

According to the present disclosure, the shapes of the screw threads of the bolt-shaped chocolate and the nut-shaped chocolate are each formed by differentiable curves. Additionally, the shapes of the screw threads each have arc-shaped crests and arc-shaped roots, and a radius of each of arc shapes of the arc-shaped crests and roots is four or more times 0.1 mm and twelve or less times 0.1 mm. Such structural features of the chocolates enables easy removal of the screw threads of these chocolates from thread portions of the molds, thereby enabling easy pushing of the chocolates out of the molds for removal. As a result, a bite-sized threaded chocolate having a small overall size can be formed, and production yield can be improved.

### BRIEF DESCRIPTION OF DRAWINGS

FIG. 1A is a top view illustrating a shape of a bolt-shaped chocolate;

FIG. 1B is a side view illustrating the shape of the bolt-shaped chocolate;

FIG. 2A is a top view illustrating a shape of a nut-shaped chocolate;

FIG. 2B is a side view illustrating the shape of the nut-shaped chocolate;

FIG. 3A is a view illustrating a state in which the bolt-shaped chocolate is fitted into the nut-shaped chocolate;

FIG. 3B is a view illustrating threads of the bolt-shaped and nut-shaped chocolates in the state in which the bolt-shaped chocolate is fitted to the nut-shaped chocolate;

FIG. 4A is an enlarged view illustrating a thread (example 1);

FIG. 4B is an enlarged view illustrating the thread (example 2);

FIG. 5A is a view illustrating a bolt shape forming mold for forming the bolt-shaped chocolate;

FIG. 5B is a view illustrating a nut shape forming mold for forming the nut-shaped chocolate;

FIG. 6 is a flowchart of a process of making a threaded chocolate;

FIG. 7 is a view illustrating deformation of the bolt shape forming mold;

FIG. 8 is a view illustrating molding of liquid chocolate;

FIG. 9 is a view illustrating forces occurring in the thread when the thread is pushed;

FIG. 10 is a view illustrating forces occurring in the thread during pulling out;

FIG. 11A is a view illustrating an example of a shape of the thread in a case in which radii of arc shapes are small;

FIG. 11B is a view illustrating an example of the shape of the thread when the arc shapes of the crests and roots reach middle points between the crests and roots;

FIG. 11C is a view illustrating an example of the shape of the thread in a case in which arc shapes of the crests and roots have radii larger than the radii of the arc shapes of the crests and roots illustrated in FIG. 11B;

FIG. 12 is a graph illustrating a relationship between radii of arc shapes of the crests and roots of the thread, production yield, and heights of thread engagement between the bolt and nut;

FIG. 13 is a view illustrating another example of the shape of the thread;

FIG. 14A is a view illustrating another example of the bolt shape forming mold; and

FIG. 14B is a view illustrating another example of the nut shape forming mold.

### DESCRIPTION OF EMBODIMENTS

An embodiment of the present disclosure is described below in detail with reference to the drawings. Components that are the same or equivalent are assigned the same reference signs throughout the drawings.

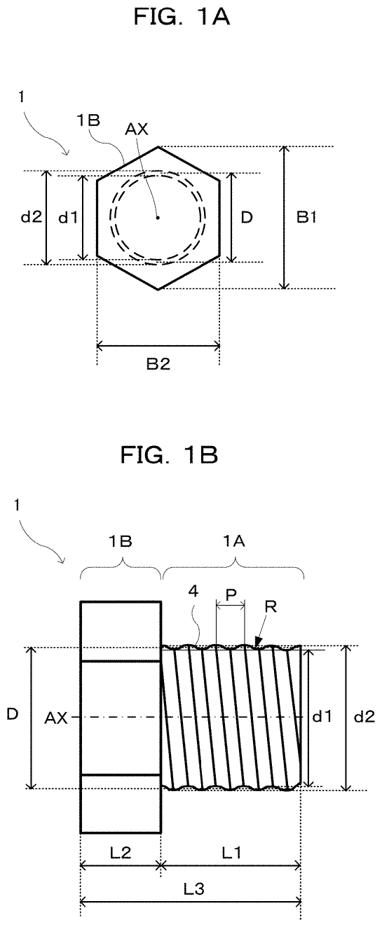

As illustrated in FIGS. 1A and 1B, a bolt-shaped chocolate 1 is shaped like a bolt. That is, the bolt-shaped chocolate 1 includes a male thread portion 1A having a thread 4 and a hexagon-shaped head 1B having a diameter larger than a diameter of the male thread portion 1A. At the male thread portion 1A, a center axis that is a center of rotation of the male thread portion 1A is referred to as an “AX axis”. Also, a symbol “D” denotes an effective diameter, that is, a diameter of an imaginary cylinder formed where widths of the thread 4 are equal to widths of the thread grooves. Also, a symbol “d1” denotes a diameter of the innermost portion of the male thread portion 1A that is a distance between upper-side roots and lower-side roots of the thread 4, a symbol “d2” denotes an outer diameter that is a distance between upper-side crests and lower-side crests of the thread 4, a symbol “P” denotes a pitch, and a symbol “L1” denotes a length of the male thread portion 1A in an AX-axis direction. Also, a symbol “B1” denotes a maximum dimension of the head 1B, a symbol “B2” denotes a width across flats of the head 1B, and a symbol “L2” denotes a height of the head 1B. Also, a symbol “L3” denotes a length of the bolt-shaped chocolate 1 in the AX-axis direction. The sum of the lengths L1 and L2 is the length L3.

The bolt-shaped chocolate 1 is a bite-sized chocolate that can be put as is into the mouth. The term, “bite-sized chocolate”, means a chocolate having a size small enough that normal adults can eat the chocolate in one mouthful without altering the shape of the chocolate, and the sizes of bite-sized chocolates generally are 3 by 3 by 3 cm or less. However the bite-sized chocolates may have a dimension in one direction that is longer than 3 cm and is 4.5 cm or less. Average mouth width of the Japanese is considered to be 4.5 cm. As described above, the maximum dimension B1 is to be 3.0 cm or less, and the length L3 of the bolt-shaped chocolate 1 in the AX-axis direction is to be 3.0 cm or less.

For example, the maximum dimension B1 of the head 1B of the bolt-shaped chocolate 1 is 23.09 mm, and the width B2 across the flats is 20.0 mm. Also, the height L2 of the head 1B of the bolt-shaped chocolate 1 is 8.00 mm, the length L1 of the thread 4 of the male thread portion 1A is 14.00 mm, and the length L3 of the bolt-shaped chocolate 1 in the AX-axis direction is 22.00 mm. Also, the effective diameter D of the thread is, for example, 14.00 mm, and the diameter d1 of the root of the thread is 13.36 mm. Also, the outer diameter d2 is, for example, 14.96 mm. However, the dimensions of the bolt-shaped chocolate 1 are not limited to the above-described numerical values.

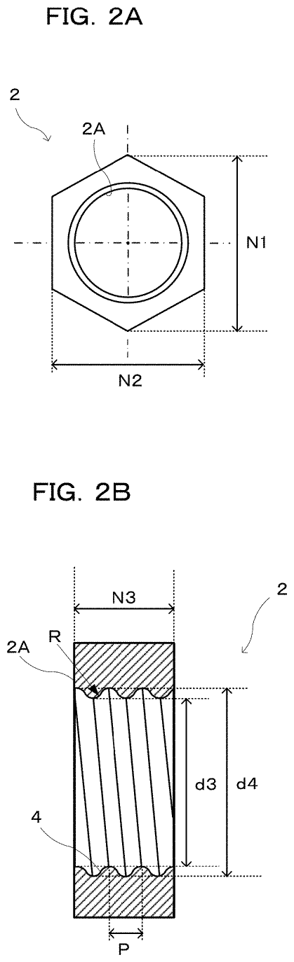

As illustrated in FIGS. 2A and 2B, a nut-shaped chocolate 2 is shaped like a nut. That is, the nut-shaped chocolate 2 includes a female thread portion 2A having a thread 4. The nut-shaped chocolate 2 has a hexagon-shaped external shape. A symbol “N1” denotes a maximum dimension of the nut-shaped chocolate 2, a symbol “N2” denotes a width across the flats of the nut-shaped chocolate 2, and a symbol “N3” denotes a height of the nut-shaped chocolate 2. Also, in the female thread portion 2A, a symbol “d3” denotes an inner diameter that is a distance between distal crests of the thread 4, and a symbol “d4” denotes a diameter of the roots that is a distance between the bottoms of the roots of the thread 4. Like the bolt-shaped chocolate 1, the nut-shaped chocolate 2 is also a bite-sized chocolate that can be put as is into a mouth. Accordingly, the maximum dimension N1 and the height N3 are to be 3.0 cm or less.

For example, the maximum dimension N1 of the nut-shaped chocolate 2 is 23.0 mm, and the height N3 of the female thread portion 2A in the AX-axis direction is 8.0 mm. Also, the inner diameter d3 of the female thread portion 2A is typically 14.06 mm, and the diameter d4 of the innermost portion is 15.66 mm. However, the dimensions of the nut-shaped chocolate 2 are not limited to the above-described numerical values.

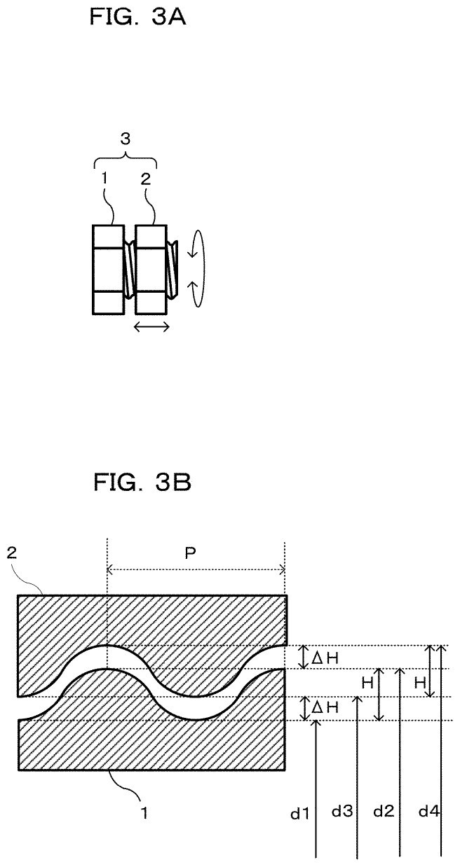

For the bolt-shaped chocolate 1 and the nut-shaped chocolate 2 as illustrated in FIG. 3A, the nut-shaped chocolate 2 is fitted to the thread 4 of the bolt-shaped chocolate 1 by hand, and the nut-shaped chocolate 2 can be rotated. The bolt-shaped chocolate 1 and the nut-shaped chocolate 2 form a threaded chocolate 3. For example, the pitches P of the threads 4 of the bolt-shaped and nut-shaped chocolates 1 and 2 are 2.82 mm.

As illustrated in FIG. 3B, bolt-shaped chocolate 1 and the nut-shaped chocolate 2 have threads 4 of the same shape, that is, cross sectional shape. The diameter d1 of the innermost portion of the bolt-shaped chocolate 1, the outer diameter d2 of the bolt-shaped chocolate 1, the inner diameter d3 of the nut-shaped chocolate 2, and the diameter d4 of the innermost portion of the nut-shaped chocolate 2 have the following relationship: d1<d3<d2<d4. The difference between d1 and d2 is equal to the difference between d3 and d4 and is H. The difference between d1 and d3 and the difference between d2 and d4 are the same value ΔH. As a result, the bolt-shaped chocolate 1 can be fitted into the nut-shaped chocolate 2 with a clearance of ΔH. The difference ΔH is, for example, 0.35 mm, without particular limitation.

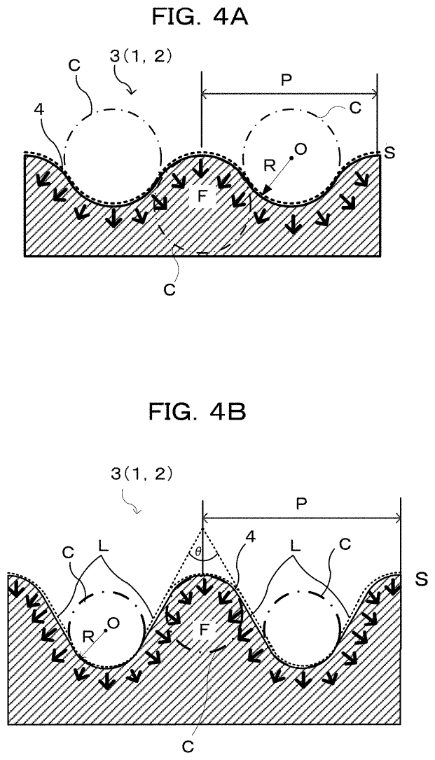

FIG. 4A schematically illustrates an example of the shapes (cross sectional shapes) of the threads 4 of the bolt-shaped chocolate 1 and the nut-shaped chocolate 2. As illustrated in FIG. 4A, the shapes (cross sectional shapes) of the threads 4 are each formed by a differentiable curve S. The curve S is accentuated by an auxiliary line (dashed line) in FIG. 4A. The term, “differentiable curve”, means a curve that does not have any corners, that is, cusps. In this case, a rounded portion for chamfering of a sharp corner of a bending portion is formed without considering tangents of lines of the threads connecting with the rounded portion. A curve formed in such a manner is considered to be not differentiable. The differentiable curve S of the present embodiment is a curve in which a single tangent touching the curve S is defined at every point of the curve S, threads having a rounded portion formed by chamfering or the like are not regarded as the threads 4 formed by differentiable curves.

Accordingly, the threads 4 do not have any corners like crests of triangular threads. The use of the threads having no corners enables reduction of internal stress concentration. As a result, the threads 4, and thus the bolt-shaped chocolate 1 and the nut-shaped chocolate 2, tend not to easily break.

In FIG. 4A, radii R of arc shapes C of the thread shapes are greater than a quarter of the pitch P of the threads, and the shapes of the threads 4 are each formed by connecting the arc shapes C. Different arc shapes C are connected with each other via end points of the adjacent arc shape C that have the same tangent. As a result, directions of forces F communicated to the nut-shaped chocolate 2 from the threads 4 of the bolt-shaped chocolate 1 or directions of opposite forces are dispersed. By dispersion of the directions of the forces F communicated to the threads 4, the threads 4 tend not to easily become chipped and the bolt-shaped chocolate 1 and the nut-shaped chocolate 2 tend not to easily break.

Also, the threads 4 are each formed to have a shape formed by connecting the arc shapes C, thereby achieving a chocolate that tends not to easily break overall, and thus the overall bolt-shaped chocolate 1 and the nut-shaped chocolate 2 can be reduced in size. As a result, the bite-sized bolt-shaped chocolate 1 and the bite-sized nut-shaped chocolate 2 can be achieved.

As another example different from the example of the shapes of the threads 4 each formed by a differentiable curve as illustrated in FIG. 4A, FIG. 4B illustrates a shape formed by connecting straight lines L with arc shapes C. Radii R of the arc shapes C of each of the threads 4 are less than a quarter of the pitch P, and tangent lines at end portions of the arc shapes C coincide with the straight lines L. Also in the case in which the curve S expressing the shape of each of the threads 4 is formed by connecting straight lines L with arc shapes C as illustrated in FIG. 4B, directions of forces F applied to the thread 4 of the nut-shaped chocolate 2 from the thread 4 of the bolt-shaped chocolate 1 or directions of opposite forces can be dispersed. By causing dispersal of the directions of the forces F applied to the threads 4, the threads 4 tend not to easily become chipped and the bolt-shaped chocolate 1 and the nut-shaped chocolate 2 tend not to break easily.

Also, in the present embodiment, the radii R of the arc shapes C is the smallest dimension (limit of production of chocolates) of dimensions that the arc shapes C actually formable as a portion of the differentiable curve have, and the smallest dimension is four or more times 0.1 mm and is twelve or less times 0.1 mm. As described below, a value that is four times 0.1 mm, that is, 0.4 mm, is the smallest value for which the influence of a dimensional error on the radii R of the arc shapes C can be ignored. Also, as described below, a value that is twelve times 0.1 mm, that is, 1.2 mm, is the greatest value of the radii R of the arc shapes C for achieving thread engagement that enables the nut-shaped chocolate 2 to be rotated by hand with the bolt-shaped chocolate 1 fitted to the nut-shaped chocolate 2. The dimension of 0.1 mm corresponds to a dimension tolerance (general tolerance) in a dimensional division ranging from 0.5 mm to 3 mm.

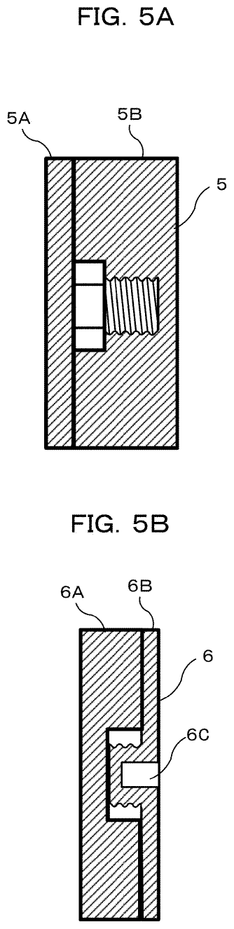

As illustrated in FIG. 5A, a bolt shape forming mold 5 is used for forming the bolt-shaped chocolate 1. The bolt shape forming mold 5 is formed by, for example, a flexible member made of silicon. The bolt shape forming mold 5 includes an upper mold part 5A and a lower mold part 5B. The lower mold part 5B has a space (cavity) in which the bolt-shaped chocolate 1 is molded.

Also, as illustrated in FIG. 5B, a nut shape forming mold 6 is used for forming the nut-shaped chocolate 2. The nut shape forming mold 6 is also formed by, for example, a flexible member made of silicon. The nut shape forming mold 6 includes an upper mold part 6A and a lower mold part 6B. The upper mold part 6A and the lower mold part 6B form a space (cavity) in which the nut-shaped chocolate 2 is molded.

Actually, the bolt shape forming mold 5 has spaces (cavities) in which bolt-shaped chocolates 1 are formed simultaneously, and the nut shape forming mold 6 has spaces (cavities) in which nut-shaped chocolates 2 are formed simultaneously.

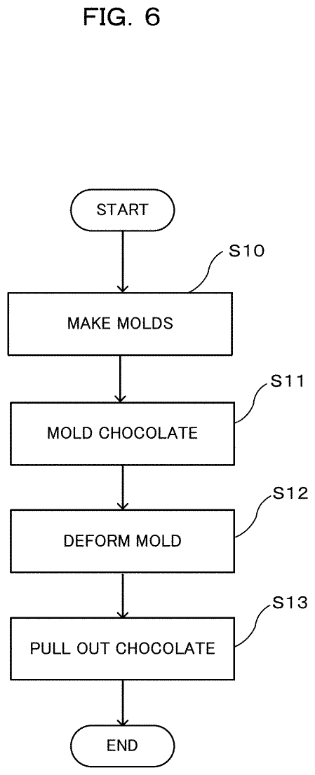

Next, a manufacturing method of forming the bolt-shaped chocolate 1 and the nut-shaped chocolate 2 is described. FIG. 6 illustrates a flowchart of the manufacturing method of forming the bolt-shaped chocolate 1 and the nut-shaped chocolate 2.

As illustrated in FIG. 6, the bolt shape forming mold 5 and the nut shape forming mold 6 are first made (Step S10, a mold making step). Each of the bolt shape forming mold 5 and the nut shape forming mold 6 is made of a flexible material. Also, as illustrated in FIGS. 4A and 4B, the portions corresponding to the threads 4 are formed to each have a shape expressed by a differentiable curve, and crests and roots of the threads each have the arc shape C. The radius R of the arc shape C is four or more times 0.1 mm and is twelve or less times 0.1 mm.

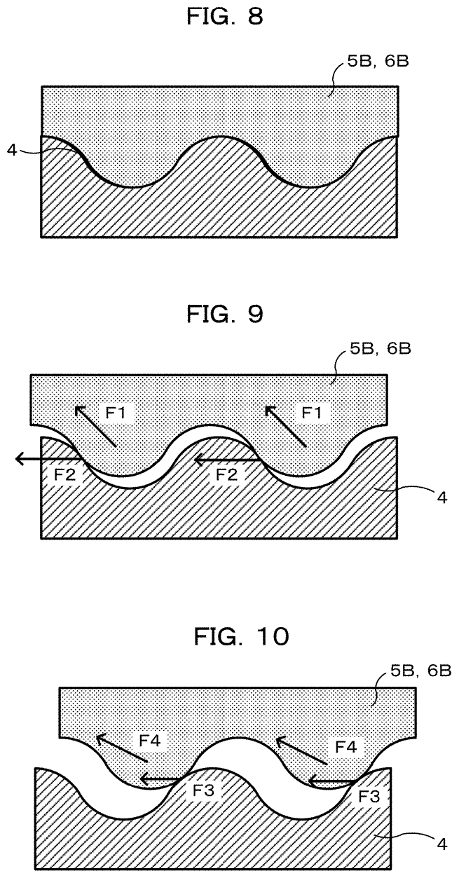

Subsequently, liquid chocolate (chocolate liquid) is cast in the bolt shape forming mold 5 and the nut shape forming mold 6 (Step S11: a molding step). In the molding step, the bolt-shaped chocolate 1 is formed in the bolt-shape forming mold 5, and the nut-shaped chocolate 2 is formed in the nut-shape forming mold 6. In this state, for example, the thread 4 of the bolt shape forming mold 5 completely meshes with the thread 4 of the bolt-shaped chocolate 1 as illustrated in FIG. 8.

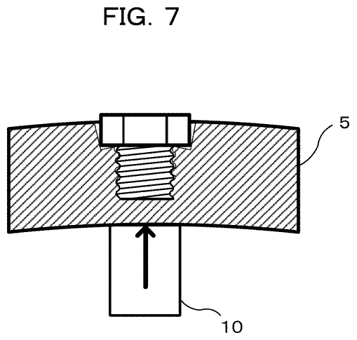

Subsequently, in order to remove the bolt-shaped chocolate 1 and nut-shaped chocolate 2 from the molds, the bolt shape forming mold 5 and the nut shape forming mold 6 are deformed (Step S12: a deformation step). Specifically, as illustrated in FIG. 7 for example, a press rod 10 is pressed against the bottom of the lower mold part 5B so as to deform the bolt shape forming mold 5.

As illustrated in FIG. 9 for example, the deformation of the bolt shape forming mold 5 causes the thread 4 of the bolt shape forming mold 5 to deform and move away from the thread 4 of the bolt-shaped chocolate 1 in a direction F1 and to push the thread 4 of the chocolate 1 in a direction F2. As a result, as illustrated in FIG. 7, the bolt-shaped chocolate 1 is partially pushed out from the bolt shape forming mold 5. Since the bolt shape forming mold 5 is flexible and the threads 4 are formed to have the shape formed by the differentiable curve, stress concentration is alleviated in the thread 4 of the bolt-shaped chocolate 1 even though the thread 4 of the bolt-shaped chocolate 1 undergoes the force of pressing by the press rod.

As illustrated in FIG. 5B, a female thread portion of the lower mold part 6B of the nut shape forming mold 6 has a cavity 6C. The cavity 6C enables easy deformation of the female thread portion of the lower mold part 6B. Accordingly, the nut-shaped chocolate 2 is in a state in which the chocolate 2 can be easily removed from the nut shape forming mold 6 by the deformation of the mold 6. For example, the female portion of the lower mold part 6b is deformed by sucking air into the cavity 6C, thereby enabling easy removal of the nut-shaped chocolate 2 from the mold 6.

Subsequently, the bolt-shaped chocolate 1 and the nut-shaped chocolate 2 are respectively pulled out of the bolt shape forming mold 5 and the nut shape forming mold 6 (Step S13: a pulling step). In this state, as illustrated in FIG. 7, the head 1B of the bolt-shaped chocolate 1 protrudes from the bolt shape forming mold 5. A robot arm not illustrated in the drawings grips the head 1B to pull the bolt-shaped chocolate 1 out of the mold 5. During pulling of the bolt-shaped chocolate 1, as indicated by arrows F3 illustrated in FIG. 10, the thread 4 of the bolt-shaped chocolate 1 abuts the thread of the bolt shape forming mold 5. However, the thread of the flexible bolt shape forming mold 5 is deformed in a direction indicated by arrows F4, thereby enabling pulling out without breakage of the threads 4 of the bolt-shaped chocolate 5. In this case, since the threads 4 are formed to have the shape expressed by the differentiable curve, stress concentration is alleviated in the thread 4 of the bolt-shaped chocolate 1 even though the thread 4 of the chocolate 1 undergoes forces from the bolt shape forming mold 5 during pulling of the chocolate 1 out of the mold 5. The same holds true for the nut-shaped chocolate 2.

FIG. 7 illustrates upward pulling of the bolt-shaped chocolate 1 out of the bolt shape forming mold 5. However, in the actual pulling step, the bolt shape forming mold 5 may be turned over so that the bolt-shaped chocolate 1 is pulled downward out of the mold 5. In this case, the bolt-shaped chocolate 1 can be easily pulled out of the mold 5 using the force of gravity. The same holds true when pulling the nut-shaped chocolate 2 out of the nut shape forming mold 6.

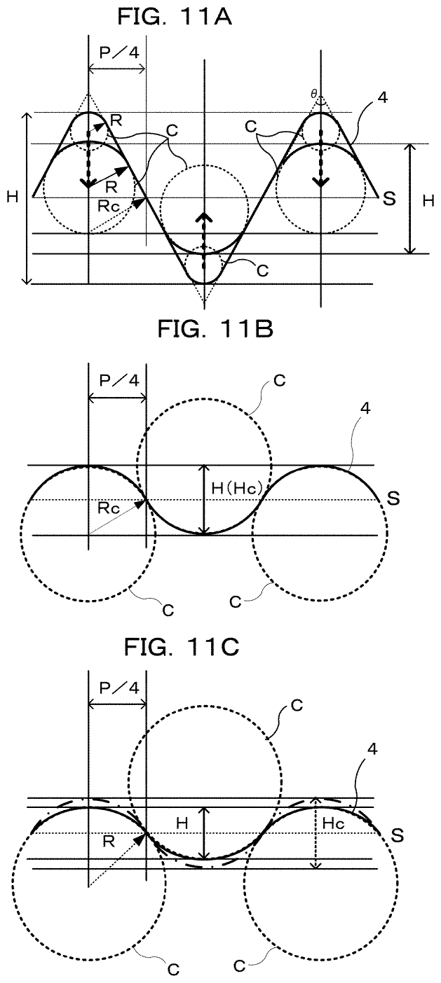

Next, a result of a change of the radii of the arc shapes C of the threads 4 is described in a case in which the radii of the arc shapes of the threads 4 are R and the threads 4 have the constant pitch P as described above. As illustrated in FIG. 11A, the radii R of the arc shapes C of the threads 4 are first set to have a value at which the radii R are sufficiently less than the pitch P of the threads, and the value of the radii R is gradually increased. In this case, since threads are difficult to form so that the shapes of the threads are expressed by a differentiable curve S including an arc shape C the radius of which is less than 0.1 mm, the minimum value of the radii R is set to be 0.1 mm. With increase in the value of the radii R of the arc shapes from 0.1 mm, the shapes of the threads 4 are formed by connecting the arc shapes C with the straight lines L as illustrated in FIG. 4B until the arc shapes C reach middle points between the crests and the roots. In this case, the shapes of the threads 4 have the same vertex angle θ (an angle between the virtually extending straight lines L, for example 60°). In such shapes, although the engagement height H is generally high, the threads 4 are likely to chip due to the high engagement height H. With an increase in the value of the radii R of the arc shapes C, the engagement height H decreases. To prevent complexity of the drawings, in FIGS. 11A to 11C, the differences in height between the crests and the roots of the threads 4 (the height H illustrated in FIG. 3B) are illustrated as the engagement height H for convenience.

When the value of the radii R of the arc shapes C is further increased, as illustrated in FIG. 11B, the radii R has a value Rc, the arc shapes C reach the middle points between the crests and roots of the threads 4, and the threads 4 each have a shape (cross-sectional shape) obtained by connecting the arc shapes C. A symbol Hc denotes the engagement height H in this case. The radii Rc of the arc shapes in FIG. 11B is, for example, 0.82 mm.

Also, as illustrated in FIG. 11C, when the value of the radii R of the arc shapes C is greater than the value Rc, the contact areas between the arc shapes C forming convex potions of the threads and the arc shapes C forming concave portions of the threads are reduced, and the differences in height between the crests and the roots are reduced. As a result, although the engagement height H in this case is less than the engagement height He due to the reduction in the engagement height, the threads 4 are less likely to chip.

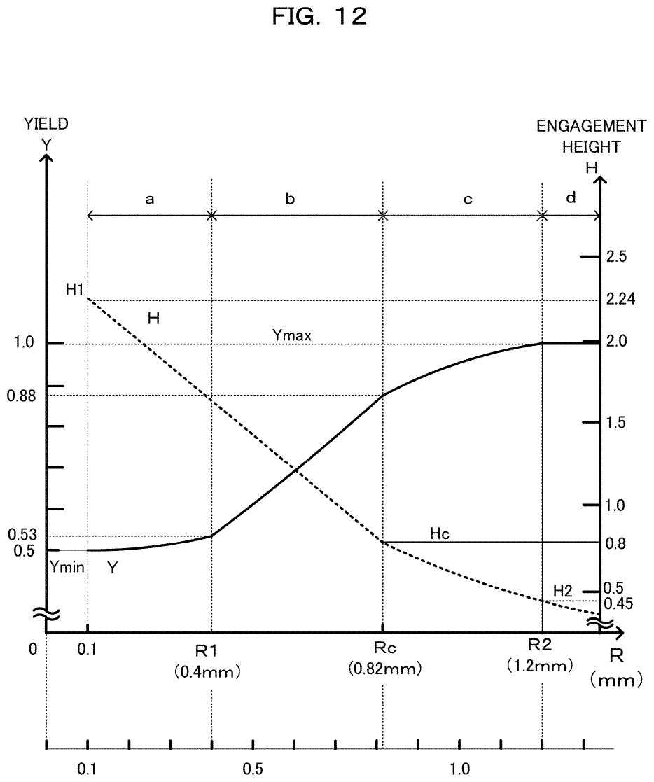

The radii R of the arc shapes C are preferably determined in consideration of production yield and the engagement height H. FIG. 12 illustrates a change in yield Y (solid line) and a change in the engagement height H (dotted line) in the case in which the threads 4 have the same pitch P (the threads 4 have the same vertex angle θ in the case of the shapes of the threads 4 illustrated in FIG. 11A) and the value of the radii R of the arc shapes C is changed. In the graph of FIG. 12, the production yield Y means a ratio of the number of chocolates other than defective chocolates among produced chocolates to the total number of the produced chocolates.

As illustrated in FIG. 12, when the radii R of the arc shapes C have the minimum value, that is, 0.1 mm, the engagement height H has the maximum value H1 (2.24 mm) and the yield Y has the minimum value Y mm (0.5).

As illustrated in FIG. 12, with an increase in the value of the radii R of the arc shapes C from 0.1 mm, the engagement height H decreases and the yield Y increases. A tradeoff occurs between the yield Y and the engagement height H with change in the value of the radii R of the arc shapes C.

A degree of an increase in the yield Y and a degree of a decrease in the engagement height H vary in accordance with the value of the radii R of the arc shapes. First, since errors of measurements of the radii R of the arc shapes cannot be ignored in a range a in which the value of the radii R of the arc shapes C is 0.1 mm or more and R1 (0.4 mm) or less, the increase in the yield Y from 0.5 is gradual. The engagement height H linearly decreases with an increase in the value of the radii R of the arc shapes C.

Since the errors of measurements of the radii R of the arc shapes (including dimensional tolerance) have less influence in a range b in which the value of the radii R of the arc shapes C is R1 (0.4 mm) or more and Rc (0.82 mm) or less, the degree of an increase in the yield Y increases with increase in the value of the radii R of the arc shapes C. However, the degree of a decrease in the engagement height H is the same as that in the range a.

When the value of the radii R of the arc shapes C is Rc (0.82 mm), the shapes of the threads 4 change from the shapes illustrated in FIG. 11A to the shapes illustrated in FIG. 11B. The threads 4 have shapes illustrated in FIG. 11C in a range c in which the value of the radii R of the arc shapes C is Rc or more and R2 (1.2 mm) or less. Regarding these shapes, a ratio of a change in the engagement height H to a change in the value of the radii R of the arc shapes C in the range c is lower than that in the range b. Accordingly, the degree of an increase in the yield Y also becomes low.

In a range din which the value of the radii R of the arc shapes C is greater than R2 (1.2 mm), the yield Y converges to a value Y max (1.0). The engagement height H has a value that is not greater than the smallest value H2 (0.45 mm) at which the bolt-shaped chocolate 1 can be rotated by hand with the bolt-shaped chocolate 1 fitted to the nut-shaped chocolate 2. The minimum value H2 is greater than the value ΔH (0.35 mm) illustrated in FIG. 4.

As described above, the degree of the change in the yield Y and the degree of the change in the engagement height H vary in accordance with the ranges a, b, c and d regarding the value of the radii R of the arc shapes C. In order to obtain stable yield Y, the value of the radii R of the arc shapes C is to have a value that is R1 (0.4 mm) or more, that is, a value that is four or more times the minimum value (0.1 mm) of the value of the radii R of the arc shapes C. Additionally, in order to enable the bolt-shaped chocolate 1 to be reliably rotated by hand with the bolt-shaped chocolate 1 fitted to the nut-shaped chocolate 2, the radii R of the arc shapes C is to have a value that is twelve or less times the minimum value (0.1 mm) of the radii R of the arc shapes C or more, that is, a value that is R2 (1.2 mm). Accordingly, the radii R of the arc shapes C are to have at least a value that is four or more times 0.1 mm and twelve or less times 0.1 mm.

Since the threads 4 are formed to have the shape expressed by the arc-shaped curve, the bolt-shaped chocolate 1 and the nut-shaped chocolate 2 can be more smoothly rotated by hand than a case in which the threads 4 are formed to have triangular shapes. When the radii R of the arc shapes C are too small, the shapes of the threads 4 are approximately triangular. As a result, the smoothness of the rotation of the nut-shaped chocolate 2 is reduced, and thus the threads 4 easily chip. When the radii R of the arc shapes C are too large, looseness between the bolt-shaped chocolate 1 and the nut-shaped chocolate 2 is remarkable, and smooth rotation is difficult. The inventors studied the ease of rotation by changing the value of the radii R of the arc shapes C, finding that the range of the radii R of the ark shapes C enabling the chocolate 2 to be smoothly rotated relative to the chocolate 1 by hand was four or more times 0.1 mm and twelve or less times 0.1 mm.

Additionally, even when the type of material of the chocolates 1 and 2 was changed, the characteristics illustrated in FIG. 12 remained unchanged.

Also, even though the value of the pitch P and/or the value of the vertex angles θ of the shapes of the threads 4 is changed, the characteristics of the yield Y and the engagement height H illustrated in FIG. 12 remained unchanged. When the radii R (0.82 mm) of the arc shapes C forming the crests and the troughs of the threads 4 are set to be four or more times 0.1 mm (dimension tolerance) and twelve or less times 0.1 mm, the threaded chocolate 3 that can be rotated by hand can be produced with good yield.

As described above, in the present disclosure, the threads 4 of the bolt-shaped chocolate 1 and the nut-shaped chocolate 2 are formed to have a shape (cross sectional shape) of the differentiable curve S, and the shapes of the crests and the roots of the threads are formed by the arc shapes C. Additionally, the value of the radii R of the arc shapes C is four or more times 0.1 mm and twelve or less times 0.1 mm. Such structural features enable the threads 4 to easily slide on the thread portions of the molds during the process in which the molded bolt-shaped chocolate 1 and the molded nut-shaped chocolate 2 are pushed and pulled out of the molds in the axial direction, thereby enabling easy pushing and pulling of the bolt-shaped chocolate 1 and the nut-shaped chocolate 2 out of the molds. As a result, while reducing the overall size to make possible the production of the chocolates 1 and 2 as bite-sized chocolates, and the production yield can be improved.

Also, in the present embodiment, the threads 4 are formed to have the shape of the differential curve S, thereby alleviating stress that occurs in the threads 4. As a result, the risk of breakage of the bolt-shaped chocolate 1 and the nut-shaped chocolate 2 can be reduced.

Also, in the present embodiment, the bolt-shaped chocolate 1 and the nut-shaped chocolate 2 are respectively pushed out of the bolt shape forming mold 5 and the nut shape forming mold 6. As a result, when the threads 4 abut the thread portions of the molds to be pushed upward, a large contact area between the threads 4 and the thread portions of the molds can be achieved, and the directions of forces that the threads 4 undergo can be dispersed, thereby preventing the threads 4 from chipping.

Also, in the present embodiment, the threads 4 include the portions having the arc shapes C. The arc shapes C are shapes that enable normal directions of the surface of one thread touching another thread to be dispersed to a maximum extent. Accordingly, the arc shapes C are shapes that easily alleviate stress concentration. In a case in which the threads 4 are connected with one another via only the portions having the arc shapes C, the maximum effect of alleviating the stress concentration can be obtained.

Also, in the present embodiment, the engagement height H of the threads 4 is a height to be used, thereby making possible production of the threaded chocolate 3 under the condition that the yield Y is above a certain level.

Also, in the present embodiment, the effective diameter D of the bolt-shaped chocolate 1 is, for example, 14 mm, without particular limitation. The effective diameter D of the threads may be not only 14 mm but also, for example, may have various values in a range from 12 mm to 26 mm. Also, the dimensions B1, B2, L1, L2, N1, N2 and N3 of the bolt-shaped chocolate 1 and the nut-shaped chocolate 2 may have various values. Also, in the present embodiment, the diameter d1 of the innermost portions of the male thread portion 1A of the bolt-shaped chocolate 1 is 13.36 mm, but may be 12.2 mm. The diameter d1 of the innermost portions may be 10.6 mm or more and 24.8 mm or less. Also, the outer diameter d2 is typically 14.96 mm, but may be 13.8 mm. The outer diameter d2 may be 11.8 mm or more and 26.4 mm or less. Also, although the pitch P is typically 2.82 mm, the pitch P may be 2.54 mm or more and 3.62 mm or less. In the present embodiment, the threaded chocolate 3 may have dimensions enabling the threaded chocolate 3 to be eaten in one bite. Even though the dimensions of chocolates 1 and 2 are changed into other ones, the tradeoff still occurs between the engagement height H and the yield Y, and the value of the radii R of the arc shapes C of the threads 4 satisfying a suitable engagement height and good yield is preferably four or more times 0.1 mm and twelve or less times 0.1 mm.

Additionally, the bolt-shaped chocolate 1 may be different from the nut-shaped chocolate 2 in flavor. For example, the bolt-shaped chocolate 1 may be made of ordinary black chocolate, and the nut-shaped chocolate 2 may be made of white chocolate. As a result, when a person eats the bolt-shaped chocolate 1 and the nut-shaped chocolate 2 with the bolt-shaped chocolate 1 fitted to the nut-shaped chocolate 2, the person can taste two flavors at the same time. Flavors that can be combined include flavors such as a fruits flavor and a green tea flavor, and the person can eat various flavors of chocolates. When the person only eats the bolt-shaped chocolate 1, only eats the nut-shaped chocolate 2 differing from the bolt-shaped chocolate 1 in flavor, or eats the bolt-shaped and nut-shaped chocolates 1 and 2 in combination with each other, the person can enjoy three tastes with two flavors. Increasing the types of flavors enables an increase in the diversity of the obtainable flavors.

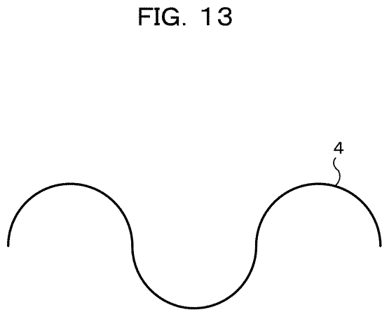

The shapes of the threads 4 are not limited to the shapes used in the above-described embodiment. For example, as illustrated in FIG. 13, the threads 4 may each have a shape obtained by connecting semicircles as the arc shapes C. Alternatively, the threads 4 may each have a shape obtained by connecting quadratic curves. As described above, the shapes of the threads 4 may be each formed by a curve, the curvature of which changes. As a result, stress concentration occurring in the thread portions is alleviated, thereby reducing the risk of overall brakeage of the chocolates.

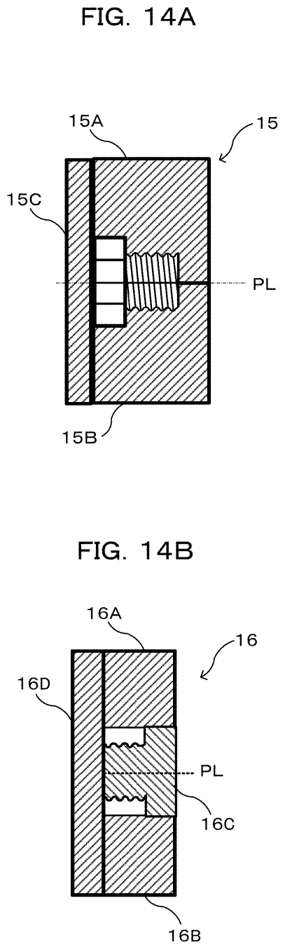

The bolt-shaped chocolate 1 may be molded using a bolt shape forming mold 15 illustrated in FIG. 14A. The bolt shape forming mold 15 may be made of metal. The bolt shape forming mold 15 includes a first split mold part 15A, a second split mold part 15B and an upper mold part 15C. The first split mold part 15A and the second split mold part 15B are separated from each other along a parting line PL including a line that corresponds to the central axis AX of the bolt-shaped chocolate 1, and a cavity having the shape of the bolt-shaped chocolate 1 is formed by the first and second split mold parts 15A and 15B. First, liquid chocolate is caste in the cavity formed by the first and second split mold parts 15A and 15B in a state in which the upper mold part 15C is not attached to the first and second split mold parts. The bolt-shaped chocolate 1 is molded with the cavity closed by the upper mold part 15C. After the molding of the bolt-shaped chocolate 1, the upper mold part 15C is removed from the first and second split mold parts, and the bolt-shaped chocolate 1 is removed by separating the first and second split mold parts 15A and 15B from each other. Even if such a bolt shape forming mold 15 is used, as illustrated in FIG. 12, the tradeoff occurs between the engagement height H and the yield Y, and the radii R of the arc shapes C of the threads 4 are preferably four or more times 0.1 mm and twelve or less times 0.1 mm.

Also, the nut-shaped chocolate 2 may be molded using a nut shape forming mold 16 illustrated in FIG. 14B. The nut shape forming mold 16 may be made of metal. The nut shape forming mold 16 includes a first split mold part 16A, a second split mold part 16B, a thread core 16C and an upper mold part 16D. A cavity is formed by connecting the first and second split mold parts 16A and 16B along a parting line PL. The thread core 16C can be rotated to insert or remove a thread portion into or from the cavity. A cavity having the shape of the nut-shaped chocolate 2 is formed by the first split mold part 16A, the second slit mold part 16B and the thread core 16C. First, liquid chocolate is cast in the cavity formed by the first and second split mold parts 16A and 16B and the thread core 16C in a state in which the upper mold part 16D is not attached to the first and second split mold parts. The nut-shaped chocolate 2 is molded with the cavity closed by the upper mold part 16D. After the molding of the nut-shaped chocolate 2, the thread core 16C is rotated to be removed from the first and second split mold parts 16A and 16B. After the upper mold part 16D is removed from the first and second split mold parts, the nut-shaped chocolate 2 is removed by separating the first and second split mold parts 16A and 16B from each other. Even if such a nut shape forming mold 16 is used, the tradeoff occurs between the engagement height H and the yield Y as illustrated in FIG. 12, and the radii R of the arc shapes C of the threads are preferably four or more times 0.1 mm and twelve or less times 0.1 mm.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefits of Japanese Patent Application No. 2017-178877, filed on Sep. 19, 2017, Japanese Patent Application No. 2017-211512, filed on Nov. 1, 2017, and Japanese Patent Application No. 2018-143306, filed on Jul. 31, 2018, the entire disclosure of which is incorporated by reference herein.

The present disclosure is applicable to threaded chocolates, each including a bolt-shaped chocolate and a nut-shaped chocolate.

### REFERENCE SIGNS LIST

1 Bolt-shaped chocolate
1A Male thread portion
1B Head
2 Nut-shaped chocolate
2A Female thread portion
3 Threaded chocolate
4 Thread
5 Bolt shape forming mold
5A Upper mold part
5B Lower mold part
6 Nut shape forming mold
6A Upper mold part
6B Lower mold part
6C Cavity
10 Press rod
15 Bolt shape forming mold
15A First split mold part
15B Second split mold part
15C Upper mold part
16 Nut shape forming mold
16A First split mold part
16B Second split mold part
16C Thread core
16D Upper mold part

What is claimed is:

1. A threaded chocolate comprising:
a bolt-shaped chocolate having a shape of a bolt; and
a nut-shaped chocolate having a shape of a nut and formed to be fitted to the bolt-shaped chocolate, wherein
shapes of screw threads of the bolt-shaped chocolate and the nut-shaped chocolate are each formed by a differentiable curve,
the shapes of the screw threads each have arc-shaped crests and arc-shaped roots, and
a radius of each of arc shapes of the arc-shaped crests and roots is four or more times 0.1 mm and twelve or less times 0.1 mm.

2. The threaded chocolate according to claim 1, wherein the bolt-shaped chocolate and the nut-shaped chocolate are each formed into a bite-shaped piece.

3. The threaded chocolate according to claim 1, wherein the bolt-shaped chocolate and the nut-shaped chocolate are different from each other in flavor.

4. A manufacturing method of making a threaded chocolate that comprises: a bolt-shaped chocolate having a shape of a bolt; and a nut-shaped chocolate having a shape of a nut and formed to be fitted to the bolt-shaped chocolate, shapes of screw threads of the bolt-shaped chocolate and the nut-shaped chocolate being each formed by a differentiable curve, the shapes of the screw threads each having arc-shaped crests and arc-shaped roots, a radius of each of arc shapes of the arc-shaped crests and roots being four or more times 0.1 mm and twelve or less times 0.1 mm,
the manufacturing method comprising:
making a bolt shape forming mold for forming the bolt-shaped chocolate and a nut shape forming mold for forming the nut-shaped chocolate;
casting liquid chocolate in the bolt shape forming mold or the nut shape forming mold to shape the liquid chocolate into the bolt-shaped chocolate or the nut-shaped chocolate;
deforming the bold shape forming mold or the nut shape forming mold to remove the bolt-shaped chocolate or the nut-shaped chocolate from the bolt shape forming mold or the nut shape forming mold; and
pulling the bolt-shaped chocolate or the nut-shaped chocolate out of the bold shape forming mold or the nut shape forming mold.

5. The manufacturing method according to claim 4, wherein the bolt-shaped chocolate or the nut-shaped chocolate is pulled downward.
